(19) United States
(12) Patent Application Publication
(10) Pub. No.: US 2015/0120239 A1
(43) Pub. Date: Apr. 30, 2015

(54) SLOPE CALCULATION DEVICE

(71) Applicant: Shimano Inc., Osaka (JP)

(72) Inventor: Junya FUJITA, Osaka (JP)

(21) Appl. No.: 14/335,134

(22) Filed: Jul. 18, 2014

(30) Foreign Application Priority Data
Oct. 24, 2013 (JP) 2013-220945

(51) Int. Cl. G01B 21/22; G01P 3/00; G01G 19/44

(52) U.S. Cl. CPC G01B 21/22; G01G 19/44; G01P 3/00
USPC 702/154

(57) ABSTRACT

A slope calculation device basically includes at least one first detection sensor, a speed sensor, a data storage device and a control unit. The at least one first detection sensor detects at least one parameter related to a first energy inputted to a bicycle by a rider of the bicycle. The speed sensor detects a travel speed at which the bicycle is traveling. The data storage device stores a total weight of the bicycle and the rider. The control unit is programmed to determine the first energy based on the parameter detected by the first detection sensor, calculate a second energy based on the travel speed detected by the speed sensor and the total weight of the bicycle and the rider stored in the data storage device. The control unit is further programmed to calculate a slope based on the first energy and the second energy.

### CROSS-REFERENCE TO RELATED APPLICATIONS

This application claims priority under 35 U.S.C. §119 to Japanese Patent Application No. 2013-220945, filed Oct. 24, 2013. The entire disclosure of Japanese Patent Application No. 2013-220945 is hereby incorporated herein by reference.

### BACKGROUND

1. Field of the Invention

This invention generally relates to a slope calculation device.

2. Background Information

When climbing a grade, a bicycle rider operates a shifter, a suspension, or the like so as to be able to climb the grade with greater comfort. Therefore, it is important to detect the slope of the road being traveled while a bicycle is traveling. For example. Japanese Laid-Open Patent Application No. 2000-108982 discloses a bicycle that detects the slope of a road being traveled using an inclination sensor (grade sensor), and automatically actuates the shifter.

### SUMMARY

Generally, the present disclosure is directed to a slope calculation device.

In the bicycle described above, a shift control unit actuates a shifter based on information from the inclination sensor. However, there is a problem in the above-described bicycle in that an inclination sensor must be added for the sole purpose of detecting a slope of the road.

An object of the present invention is to calculate the slope of the road being traveled by the bicycle without the use of an inclination sensor.

The slope calculation device according to an aspect of the present invention comprises at least one first detection sensor, a speed sensor, a data storage device and a control unit. The at least one first detection sensor is configured to detect at least one parameter related to a first energy inputted to a bicycle by a rider of the bicycle. The speed sensor is configured to detect a travel speed at which the bicycle is traveling. The data storage device is configured to store a total weight of the bicycle and the rider. The control unit is programmed to determine the first energy based on the parameter detected by the first detection sensor, calculate a second energy based on the travel speed detected by the speed sensor and the total weight of the bicycle and the rider stored in the data storage device. The control unit is further programmed to calculate a slope based on the first energy and the second energy.

In accordance with this configuration, the control unit is capable of calculating the slope using the parameter related to the first energy inputted to the bicycle, the travel speed and the total weight of the bicycle and the rider. In other words, the slope calculation device described above is capable of calculating the slope using the first detection unit and the speed detection unit. Accordingly, the slope calculation device is capable of calculating the slope without the use of an inclination sensor, which is used only for detecting a slope.

Preferably, the at least one first detection sensor includes a pedaling force sensor and a rotational speed sensor. The pedaling force sensor detects the pedaling force acting on a crank of the bicycle. The rotational speed sensor detects the rotational speed of the crank. The control unit is programmed to calculate the first energy based on the pedaling force detected by the pedaling force sensor and the rotational speed detected by the rotational speed sensor.

Preferably, the control unit is programmed to calculate an amount of change in a third energy at a first time based on the first energy inputted in a first time and an amount of change in the second energy from a second time, which is prior to the first time, to the first time. The control unit is programmed to calculate the slope based on a calculated amount of change in the third energy.

Preferably, the control unit is programmed to subtract the amount of change in the second energy from the first energy to calculate the amount of change in the third energy.

Preferably, the control unit is programmed to calculate the slope based on a distance travelled by the bicycle in the first time and the amount of change in the third energy.

Preferably, the pedaling force sensor detects as the pedaling force the torque acting on a crankshaft of the bicycle.

Preferably, the rotational speed sensor detects the cadence of the crank as the rotational speed.

the control unit is programmed to calculate the first energy by totaling a first partial energy for a first time duration as follows:

$${p}_{1} = T \frac{2 π n}{60} Δ t \qquad ( 1 )$$

where p₁ is a first partial energy, T is torque, n is cadence, and Δt is a sampling interval of a pedaling force sensor.

Preferably, the control unit is programmed to calculate an amount of change in the second energy as follows:

P₂=½m(v₁²−v₂²) (2)

where m is a total weight of the bicycle and the rider, v₁ is a travel speed at a first time, and v₂ is a travel speed at a second time.

Preferably, the slope calculation device furthermore comprises a brake sensor configured to detect an actuation state of a brake of the bicycle. The control unit is further programmed not to calculate the slope upon determining a brake has been actuated based on a detection result of the brake sensor.

In accordance with the present invention, a slope can be calculated without the use of an inclination sensor.

Also other objects, features, aspects and advantages of the disclosed slope calculation device will become apparent to those skilled in the art from the following detailed description, which, taken in conjunction with the annexed drawings, discloses several illustrative embodiments of the slope calculation device.

### BRIEF DESCRIPTION OF THE DRAWINGS

Referring now to the attached drawings which form a part of this original disclosure:

FIG. 1 is a side elevational view of a bicycle that is equipped with a slope calculation device in accordance with the illustrated embodiments;

FIG. 2 is a block diagram of the slope calculation device in accordance with an illustrated embodiment;

FIG. 3 is a schematic diagram showing a grade to be ascended by a bicycle;

FIG. 4 is a flow chart showing a process executed by the control unit of the slope calculation device in accordance with the first embodiment;

FIG. 5 is a block diagram of a slope calculation device in accordance with a first modification; and

FIG. 6 is a flow chart showing a process executed by the control unit of the slope calculation device in accordance with the first modification.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

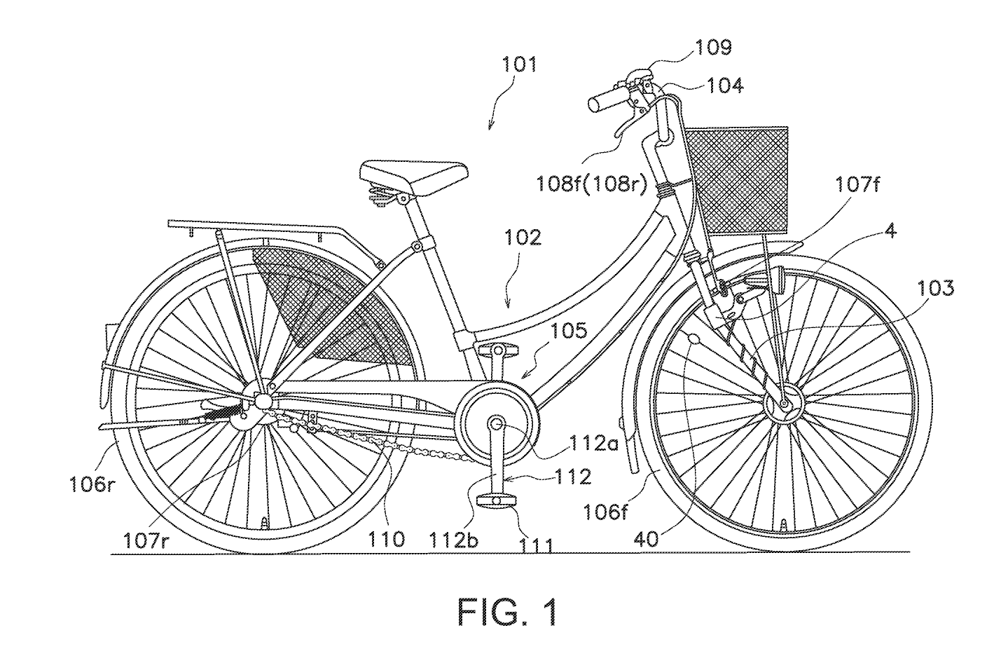

FIG. 1 is a side view of a bicycle 101 in which the slope calculation device is used.

As shown in FIG. 1, the bicycle 101 in which the slope calculation device is used is provided with a frame 102, a handlebar 104, a drive unit 105, a front wheel 106f and a rear wheel 106r. The bicycle 101 is furthermore provided with a front brake 107f, a rear brake 107r, a front brake lever 108f, a rear brake lever 108r and a display device 109.

The drive unit 105 has a chain 110 and a crank 112 on which pedals 111 are mounted. The crank 112 includes a crankshaft 112a and a pair of crank arms 112b. The crank arms 112b are disposed on both sides of the crankshaft 112a.

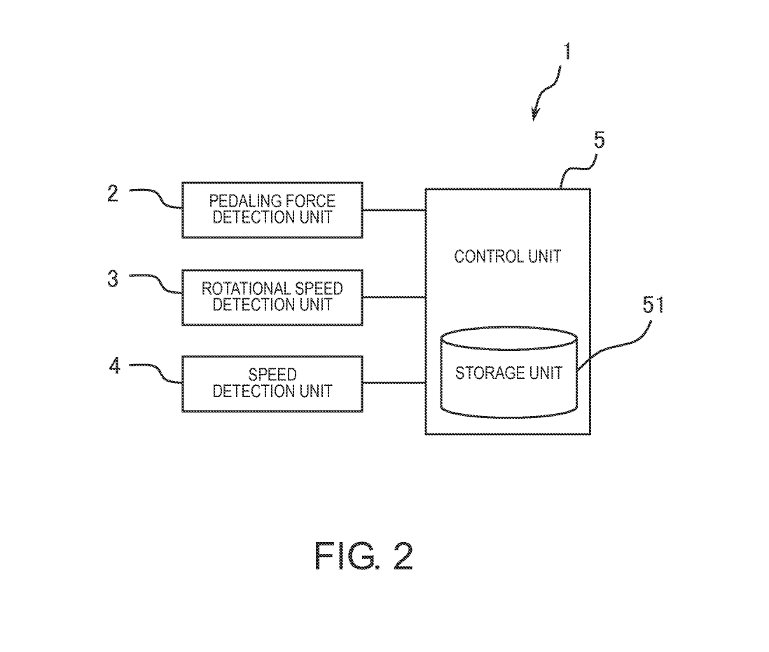

FIG. 2 is a block view showing the configuration of the slope calculation device 1 according to an embodiment. The slope calculation device 1 is provided with a pedaling force detection unit 2, a rotational speed detection unit 3, a speed detection unit 4, a control unit 5 and a storage unit 51, as shown in FIG. 2. The pedaling force detection unit 2 and the rotational speed detection unit 3 correspond to the first detection unit of the present invention.

The pedaling force detection unit 2 detects the pedaling force acting on the crank 112. For example, the pedaling force detection unit 2 is a torque sensor for detecting torque acting on the crankshaft 112a of the crank 112. More specifically, the pedaling force detection unit 2 outputs a signal (e.g., voltage) that corresponds to the torque acting on the crankshaft 112a. The torque sensor may be, e.g., a magnetostrictive sensor or a strain gauge sensor. Information related to the torque detected by the pedaling force detection unit 2 is sent to the control unit 5.

The rotational speed detection unit 3 detects the rotational speed of the crank 112. For example, the rotational speed detection unit 3 is a cadence sensor for detecting the cadence of the crank 112 as the rotational speed. More specifically, the rotational speed detection unit 3 is mounted on the frame 102 and detects a magnet mounted on the crankshaft 112b. Information related to the rotational speed detected by the rotational speed detection unit 3 is sent to the control unit 5.

The speed detection unit 4 detects the travel speed of the bicycle 101. For example, the speed detection unit 4 is a speed sensor. More specifically, the speed detection unit 4 is mounted on a front fork 103 of the bicycle 101 and detects a magnet 40 mounted on one spoke of the front wheel 106f (see FIG. 1). Information related to the travel speed of the bicycle 101 detected by the speed detection unit 4 is sent to the control unit 5. The control unit 5 calculates the travel speed of the bicycle 101 each time the front wheel 106f rotates. The travel speeds calculated for each single rotation of the front wheel 106f indicate the average travel speed of the bicycle 101 in the interval that the front wheel 106f rotates. Specifically, the control unit 5 divides the tire circumference of the front wheel 106f by the time t required for the front wheel 106f to make a single rotation to thereby calculate the travel speed of the bicycle 101 for each single rotation of the front wheel 106f.

The control unit 5 calculates a first energy and a second energy, and calculates the slope based on the calculated first and second energies. Here, the first energy shows the energy inputted to the bicycle 101 by the rider of the bicycle 101. In other words, the first energy shows the energy inputted to the bicycle 101 by the rider turning the pedals 111 of the bicycle 101.

More specifically, the control unit 5 calculates a first energy P1 inputted at a first time t1 based on the pedaling force detected by the pedaling force detection unit 2 and the rotational speed, i.e., cadence detected by the rotational speed detection unit 3. Specifically, the control unit 5 first calculates the first partial energy p₁ based on the following formula (1). As used herein, the term first partial energy p₁ refers to the energy inputted to the bicycle 101 in a sampling interval Δt of the pedaling force detection unit 2 among the first energy P1 inputted to the bicycle 101 at a first time t1.

$$\begin{matrix}Formula 1 & \\ {p}_{1} = T \frac{2 π n}{60} Δ t & ( 1 )\end{matrix}$$

In formula (1), p₁ (W) is a first partial energy, T (N·m) is the torque detected by the pedaling force detection unit 2, n (rpm) is the cadence, and Δt(s) is the sampling interval of the pedaling force detection unit 2.

The control unit 5 calculates the first energy P1 inputted to the bicycle 101 in the first time t1 based on the first partial energy p₁. More specifically, the control unit 5 calculates the integral value in the first time t1 of the first partial energy p₁ as the first energy P1. In this case, the first time t1 may be the interval for the speed detection unit 4 to detect the magnet 40 mounted on a single spoke of the front wheel 106f, i.e., the time for the front wheel 106f to make a single rotation. Consequently, the first time t1 may be not be a fixed time, but rather a time that is different for each rotation of the front wheel 106f.

The control unit 5 calculates amount of change P2 in the second energy from a second time t2, which is the speed detection interval prior to the first time t1, to the first time t1 based on the travel speed detected by the speed detection unit 4 and the total weight of the bicycle and the rider. Specifically, the control unit 5 calculates the amount of change P2 in the second energy from the average value of the second energy in the first time t1 and the average value of the second energy in the second time t2, based on following formula (2).

Formula 2

P₂=½m(v₁²−v₂²) (2)

In formula (2), m (kg) is the total weight of the bicycle 101 and the rider of the bicycle 101, v₁ (m/s) is the travel speed in the first time t1, and v₂ (m/s) is the travel speed in the second time t2. More specifically, the travel speed v₁ (m/s) indicates the average travel speed in the first time t1, and v₂ (m/s) indicates the average travel speed in the second time t2. Here, the amount of change P2 in the second energy may be calculated using 0 for the value of v₂ when the second time t2 does not exist, i.e., when the first time t1 is the first speed detection interval after the bicycle has started traveling. In this case, the total weight m of the bicycle 101 and the rider is storage in the storage unit 51. The storage unit 51 may be constituted in the memory of the control unit 5 and may be constituted in a storage device other than the control unit 5.

The control unit 5 calculates the amount of change P3 in a third energy in the first time t1 based on the first energy P1 inputted in the first time t1 and the amount of change P2 in the second energy from the second time t2 to the first time t1. More specifically, the control unit 5 subtracts the amount of change P2 in the second energy from the first energy P1 to calculate the amount of change P3 in a third energy, as shown in the following formula (3).

Formula 3

P3=P1−P2 (3)

The amount of change P3 in a third energy is the change in the potential energy in the first time t1, and the amount of change P3 in a third energy can therefore be expressed by the following formula (4).

Formula 4

P3=mgh (4)

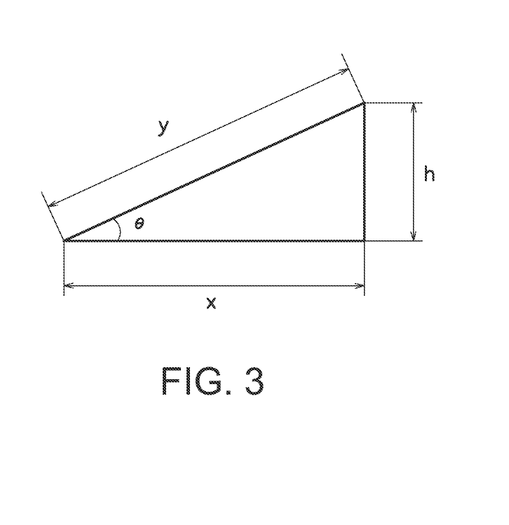

In formula (4), h (m) indicates the distance in the vertical direction that the bicycle 101 has moved in the first time t1, as shown in FIG. 3. In other words, the distance h shows the change in the height direction of the position of the bicycle 101 in the first time t1. FIG. 3 is a schematic view showing a portion of a grade. More specifically, FIG. 3 is a schematic view showing the grade of the portion of the travel distance y in which the bicycle 101 progresses in the interval of the first time t1. In formula (4), m (kg) is the total weight of the bicycle and the rider, and g (m/s2) is gravitational acceleration.

The distance h in the vertical direction can be determined using the formula (4) based on the amount of change P3 in a third energy calculated using the formula (3), the total weight m of the bicycle and the rider stored in the storage unit 51, and gravitational acceleration g.

The control unit 5 calculates the slope S from the travel distance y in the first time t1 and the distance h in the vertical direction. Specifically, the control unit 5 multiplies the first time t1 and the average travel speed v1 in the first time t1 and can thereby calculate the travel distance y, as shown in FIG. 3. The control unit 5 uses the following formula (5) to thereby calculate a distance x in the horizontal direction that the bicycle 101 has moved in the first time t1, i.e., the change in the position of the bicycle 101 in the horizontal direction in the first time t1.

Formula 5

x=\sqrt{(v₁·t₁)²−h²} (5)

The control unit 5 calculates the slope S (%) using the following formula (6) based on the distance h in the vertical direction calculated using the formula (4) above, and the distance x in the horizontal direction calculated using the formula (5) above.

$$\begin{matrix}Formula 6 & \\ S = 100 \times \frac{h}{x} & ( 6 )\end{matrix}$$

The control unit 5 may calculate the incline angle θ of a grade using the following formula (7).

$$\begin{matrix}Formula 7 & \\ θ = {tan}^{- 1} \frac{h}{x} & ( 7 )\end{matrix}$$

The control unit 5 may display the calculated slope S or the like on a display device 109 or the like mounted on the handlebar 104 or the like. As described above, the control unit 5 may calculate the slope S at each rotation of the front wheel 106f. The control unit 5 is composed of, e.g., a microcomputer, and includes a central processing unit (CPU), a random access memory (RAM), a read only memory (ROM), an I/O interface, and the like.

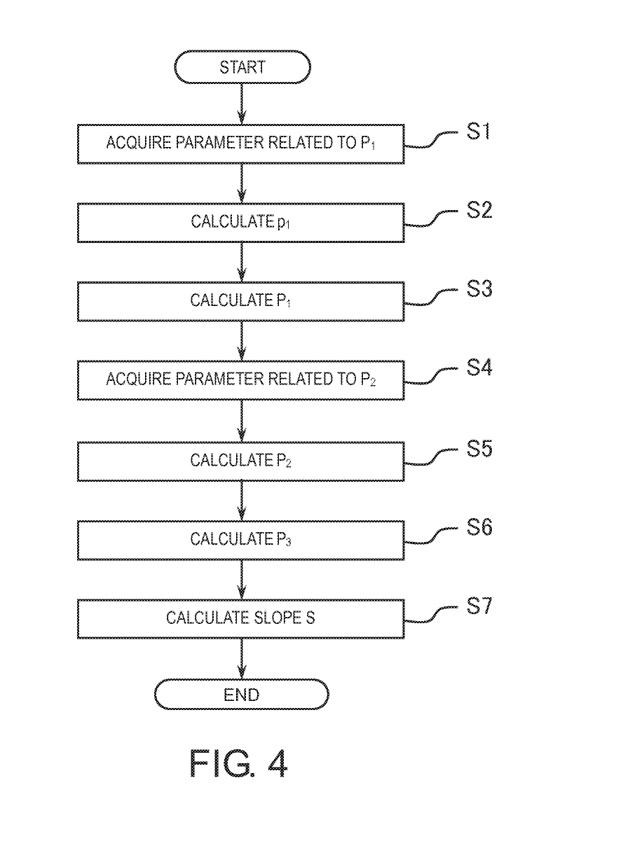

A method for calculating the slope by the slope calculation device 1 is described next with reference to FIG. 4. FIG. 4 is a flowchart for describing the operation of the slope calculation device 1 when a slope is to be calculated.

The control unit 5 acquires a parameter related to the first energy P1 inputted in the first time t1 (step S1). More specifically, the control unit 5 acquires information related to the torque that acts on the crankshaft 112a as detected by the pedaling force detection unit 2. The control unit 5 also acquires information related to the cadence of the crank 112 detected by the rotational speed detection unit 3.

Next, the control unit 5 calculates the first partial energy p₁ inputted to the bicycle 101 in the sampling interval Δt of the pedaling force detection unit 2 based on the formula (1) described above (step S2).

Next, the control unit 5 calculates the first energy P1 inputted to the bicycle 101 in the first time t1 (step S3). More specifically, the control unit 5 calculates the integral value in the first time t1 of the first partial energy p₁ as the first energy P1.

The control unit 5 subsequently acquires a parameter related to the amount of change P2 in the second energy from the second time t2 to the first time t1 (step S4). More specifically, the control unit 5 acquires the total weight nm of the bicycle 101 and the rider as stored in the storage unit 51. The control unit 5 also acquires information related to the average travel speed of the bicycle 101 in the first time t1 and the second time t2 detected by the speed detection unit 4.

Next, the control unit 5 calculates the amount of change P2 in the second energy from the second time t2 to the first time t1 based on the formula (2) described above (step S5).

The control unit 5 subsequently calculates the amount of change P3 in a third energy in the first time t1 based on the formula (3) described above (step S6).

The control unit 5 then calculates the slope S (step S7). More specifically, the control unit 5 determines the distance h in the vertical direction that the bicycle 101 has moved in the first time t1 based on the predetermined obtained in step S6 and the formula (5) described above. The control unit 5 then determines the distance x in the horizontal direction that the bicycle 101 has moved in the first time t1 based on distance h in the vertical direction and the formula (5) described above. The control unit 5 calculates the slope S based on the distance h in the vertical direction, the distance x in the horizontal direction, and the formula (6) described above.

### MODIFICATIONS

Embodiments of the present invention were described above, but the present invention is not limited thereby, and various modifications are possible within a range that does not depart from the spirit of the present invention.

### First Modification

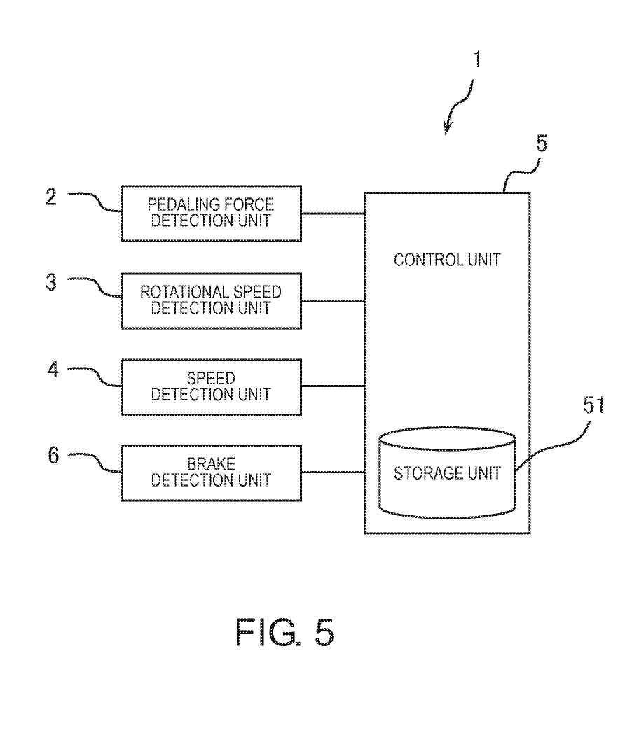

The slope calculation device 1 may furthermore be provided with a brake detection unit. FIG. 5 is a block view showing the configuration of the slope calculation device 1 according to a first modification. The slope calculation device 1 according to modification 1 is furthermore provided with a brake detection unit 6, as shown in FIG. 5. The configuration other than the brake detection unit 6 is the same as the embodiments described above and a detailed description is therefore omitted.

The brake detection unit 6 detects the actuation state of the front brake 107f and/or the rear brake 107r of the bicycle 101. For example, the brake detection unit 6 can be a brake sensor that detects whether the front brake lever 108f and/or the rear brake lever 108r has been gripped. The brake detection unit 6 outputs information related to the actuation state of the brakes to the control unit 5.

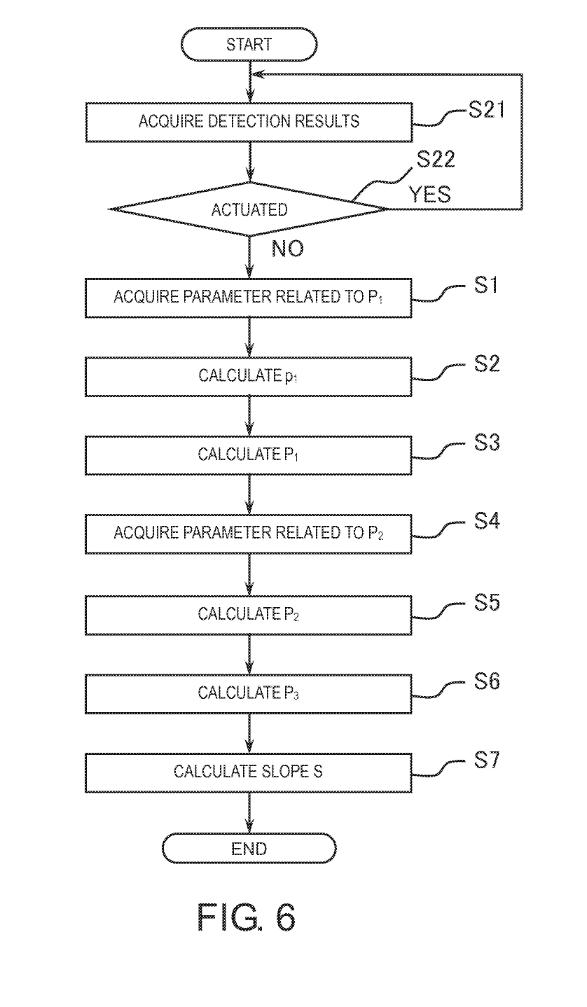

The control unit 5 acquires the detection results obtained by the brake detection unit 6, as shown in FIG. 6 (step S21). The control unit 5 assesses whether the front brake 107f and/or the rear brake 107r is actuated based on the detection results of the brake detection unit 6 (step S22).

The control unit 5 proceeds to the process of step S21 when the front brake 107f and/or the rear brake 107r is assessed to have been actuated (Yes in step S22). For example, the control unit 5 proceeds to the process of step S21 when the front brake lever 108f and/or the rear brake lever 108r is assessed to have been gripped based on the detection results of the brake detection unit 6. The processes of step S1 to step S7 are the same as the embodiments described above and a description is therefore omitted.

Meanwhile, the control unit 5 proceeds to the process of step S1 when it has been assessed that the front brake 107f and the rear brake 107r has not be actuated (No in step S22). For example, the control unit 5 proceeds to the process in step S1 when it has been assessed that the front brake lever 108f and the rear brake lever 108r is not being gripped based on the detection results of the brake detection unit 6.

### Second Modification

The total weight m of the bicycle 101 and the rider in the embodiments described above may be inputted by the rider or may be set in advance. For example, the average total weight m is stored in advance in the storage unit 51, when the total weight is set in advance.

### Third Modification

In the embodiments described above, the first time t1 is the sampling interval of the speed detection unit 4, more specifically, the time for the front wheel 106f to make a single rotation, but no limitation is imposed thereby. For example, the first time t1 may be the time for the front wheel 106f to make two rotations, or may be the time for the front wheel 106f to make three or more rotations. Additionally, the first time t1 may be set as a time unrelated to the time for the front wheel 106f to rotate. For example, the first time t1 may be a time set in advance.

Thus, the foregoing descriptions of the embodiments according to the present invention are provided for illustration only, and not for the purpose of limiting the invention as defined by the appended claims and their equivalents.

What is claimed is:

1. A slope calculation device comprising:
at least one first detection sensor configured to detect at least one parameter related to a first energy inputted to a bicycle by a rider of the bicycle;
a speed sensor configured to detect a travel speed at which the bicycle is traveling;
a data storage unit configured to store a total weight of the bicycle and the rider; and
a control unit programmed to determine the first energy based on the parameter detected by the at least one first detection sensor, calculate a second energy based on the travel speed detected by the speed sensor and the total weight of the bicycle and the rider stored in the data storage unit, and the control unit being further programmed to calculate a slope based on the first energy and the second energy.

2. The slope calculation device according to claim 1, wherein
the at least one first detection sensor includes a pedaling force sensor that detects a pedaling force acting on a crank of the bicycle and a rotational speed detection sensor that detects a rotational speed of the crank, and
the control unit is programmed to calculate the first energy based on the pedaling force detected by the pedaling force sensor and the rotational speed detected by the rotational speed sensor.

3. The slope calculation device according to claim 2, wherein
the pedaling force sensor detects a torque acting on a crankshaft of the bicycle as the pedaling force.

4. The slope calculation device according to claim 2, wherein
the rotational speed detection unit detects a cadence of the crank as the rotational speed.

5. The slope calculation device according to claim 1, wherein
the control unit is programmed to calculate an amount of change in a third energy at a first time based on the first energy inputted in a first time and an amount of change in the second energy from a second time, which is prior to the first time, to the first time, and programmed to calculate the slope based on a calculated amount of change in the third energy.

6. The slope calculation device according to claim 2, wherein
the control unit is programmed to calculate an amount of change in a third energy at a first time based on the first energy inputted in a first time and an amount of change in the second energy from a second time, which is prior to the first time, to the first time, and programmed to calculate the slope based on a calculated amount of change in the third energy,
the rotational speed sensor is mounted adjacent a wheel of the bicycle and is configured so as to detect a detection object that rotates around the rotational axis of the wheel, and
the first and second times are defined based on an interval in which the detection object is detected by the rotational speed sensor.

7. The slope calculation device according to claim 5, wherein
the control unit is programmed to subtract the amount of change in the second energy from the first energy to calculate the amount of change in the third energy.

8. The slope calculation device according to claim 5, wherein
the control unit is programmed to calculate the slope based on a distance travelled by the bicycle in the first time and the amount of change in the third energy.

9. The slope calculation device according to claim 1, wherein
the control unit is programmed to calculate the first energy by totaling a first partial energy for a first time duration as follows:
$${p}_{1} = T \frac{2 π n}{60} Δ t \qquad ( 1 )$$
where p₁ is a first partial energy, T is torque, n is cadence, and Δt is a sampling interval of a pedaling force sensor.

10. The slope calculation device according to claim 1, wherein
the control unit is programmed to calculate an amount of change in the second energy as follows:
P₂=½m(v₁²−v₂²) (2)
where m is a total weight of the bicycle and the rider, v₁ is a travel speed at a first time, and v₂ is a travel speed at a second time.

11. The slope calculation device according to claim 1, further comprising
a brake sensor configured to detect an actuation state of a brake of the bicycle,
the control unit being further programmed not to calculate the slope upon determining a brake has been actuated based on a detection result of the brake sensor.
